(19) United States
(12) Patent Application Publication
(10) Pub. No.: US 2018/0120421 A1
(43) Pub. Date: May 3, 2018

(54) LIDAR SENSOR FOR DETECTING AN OBJECT

(71) Applicant: Robert Bosch GmbH, Stuttgart (DE)

(72) Inventors: Annemarie Holleczek, Braga (PT); Nico Heussner, Ludwigsburg (DE); Stefan Spiessberger, Weinstadt (DE)

(21) Appl. No.: 15/791,985

(22) Filed: Oct. 24, 2017

(30) Foreign Application Priority Data
Oct. 28, 2016 (DE) 102016221292.3

(51) Int. Cl. G01S 7/481

(52) U.S. Cl. CPC G01S 7/4814

(57) ABSTRACT

A LIDAR sensor for detecting an object within a sensing region and a method for activating a LIDAR sensor. The LIDAR sensor includes at least one transmitting unit. The transmitting unit includes at least one source for emitting electromagnetic radiation, and at least one deflection unit for deflecting the electromagnetic radiation emitted by the source into the sensing region along a deflection direction. The transmitting unit further includes at least one transmit filter element for filtering the electromagnetic radiation deflected by the deflection unit, which the electromagnetic radiation strikes along a transmit filter input direction. The transmission behavior of the transmit filter element is a function of the transmit filter input direction.

### CROSS REFERENCE

The present application claims the benefit under 35 U.S.C. § 119 of German Patent Application No. DE 102016221292.3 filed on Oct. 28, 2016, which is expressly incorporated herein by reference in its entirety.

### FIELD

The present invention relates to a LIDAR sensor for detecting an object and a method for activating a LIDAR sensor for detecting an object.

### BACKGROUND INFORMATION

Conventional sensor devices make it possible to detect objects within a sensing region in the surroundings, for example, of a vehicle. These include, for example LIDAR sensors (LIDAR, Light Detection And Ranging). Electromagnetic radiation is emitted from a source. The electromagnetic radiation reflected or scattered on an object in the surroundings is subsequently received by a receiving unit. Not only is the useful signal detected and measured, however, but also noise from the background radiation. Optical bandpass filters (interference filters) are used to block the background radiation (for example, solar radiation). These allow the improvement of the signal-to-noise ratio. The narrower the bandpass of the filter is, the less background radiation is received by a detector of the receiving unit and the better the signal quality is. An eye-safe, compact solid body LIDAR system for measuring the profile of atmospheric clouds and aerosol scattering is described in U.S. Pat. No. 5,241,315. In this system, the photon noise of the receiver caused by natural light is controlled with the aid of a narrow field of vision of the receiver and of a temperature-controlled bandpass filter having a narrow bandwidth.

### SUMMARY

The present invention is directed to a LIDAR sensor for detecting an object within a sensing region having at least one transmitting unit. The transmitting unit includes at least one source for emitting electromagnetic radiation. The transmitting unit also includes at least one deflection unit for deflecting the electromagnetic radiation emitted from the source along a deflection direction into the sensing region.

According to the present invention, the transmitting unit further includes at least one transmit filter element for filtering electromagnetic radiation deflected by the deflection unit. The electromagnetic radiation strikes the transmit filter element along a transmit filter input direction. A transmission behavior of the transmit filter element is a function of the transmit filter input direction.

The source for emitting electromagnetic radiation may be designed as a laser. The laser may, for example, be a semiconductor laser, also called a diode laser. The electromagnetic radiation of a diode laser may be generated with laser diodes. It may be designed, for example, as a single emitter, laser bars or laser stacks. Semiconductor lasers may have spectral widths in the sub-nanometer range to as much as several 10 nm. The electromagnetic radiation may be emitted as a punctiform beam. The electromagnetic radiation may be emitted as a linear beam. Additional embodiments of geometric shapes of the beam are possible.

The transmitting unit may have an optical axis. The deflection direction may be essentially identical to the perpendicular of the surface of the transmit filter element. The electromagnetic radiation in this case may be deflected along the perpendicular of the surface of the transmit filter element into the sensing region. The deflection unit may also deflect the electromagnetic radiation along a deflection direction, which differs from the perpendicular of the surface of the transmit filter element. The electromagnetic radiation in this case may be deflected at an angle from the perpendicular of the surface of the transmit filter element.

The transmit filter input direction may be essentially identical to the perpendicular of the surface of the transmit filter element. The electromagnetic radiation in this case may strike the transmit filter element along the perpendicular of the surface of the transmit filter element. The transmit filter input direction may also differ from the perpendicular of the surface of the transmit filter element. The electromagnetic radiation in this case may strike the transmit filter element deflected at an angle to the perpendicular of the surface of the transmit filter element.

A transmit filter element within the context of the present invention may be understood to be an optical filter. An optical filter may filter the incident electromagnetic radiation according to various criteria. One criterion may be the wavelength, for example. An optical filter may, for example, be designed as an interference filter.

The transmit filter element may be situated at an angle of 90° relative to the optical axis, i.e., perpendicular to the optical axis, of the transmitting unit. The transmit filter element may be situated at an angle relative to the optical axis of the transmitting unit differing from 90°. In the latter case the transmit filter element may be situated tipped in such a way that interfering back reflections into the source may be avoided. The transmitting unit may also include an optical isolator between the source and the deflection unit in order to avoid interfering back reflections into the source.

The transmission behavior of the transmit filter element may be understood in the context of the invention to be the manner in which the transmit filter element is pervious to electromagnetic radiation. A filter element may be specified by various parameters. Thus, a filter may include a defined passband, also called bandpass range or pass range. This is the wavelength range of a filter element, within which the filter element allows the wavelengths contained in electromagnetic radiation to pass. Connected to both sides of the pass range are stopbands. A filter element may also include multiple pass ranges. A filter element may also include a central wavelength of each pass range. The central wavelength may shift to longer wavelengths as the temperature rises. A filter element may further include a half-value width of the pass range. This is the spectral width, in which the signal has dropped to 50% of the maximum value. The wavelengths and/or wavelength ranges just mentioned may alternatively also be indicated as frequencies and/or frequency ranges. The corresponding frequency may be ascertained by dividing the speed of light c by the respective wavelength.

The advantage of the present invention is that the electromagnetic radiation may be deflected with the aid of the deflection unit along a predefined direction and emitted by the transmitting unit at a predefined wavelength. One wavelength is assignable to each predefined direction. The wavelength of the emitted electromagnetic radiation may be tuned. The wavelength of the emitted electromagnetic radiation may be adjusted. Such a LIDAR sensor may be simply and cost-effectively implemented. Manufacturing-related fluctuations of the central wavelength of the source, which may amount to as much as 10 nm with normally used laser diodes, for example, may be compensated for by the adjustability of the wavelength. Moreover, the likelihood of a mutual blinding of multiple sensors is significantly reduced, since not only the instantaneous direction, along which the electromagnetic radiation is emitted by the transmitting unit into the sensing region, but also at the same time the wavelength may be sequentially changed.

In one advantageous embodiment of the present invention, it is provided that the deflection direction corresponds to the transmit filter input direction. The advantage of this embodiment is that the electromagnetic radiation strikes the transmit filter element essentially precisely in a predefined transmit filter input direction. The deflection direction may be adjusted in such a way that the wavelength of emitted electromagnetic radiation may be tuned in a predefined manner. The electromagnetic radiation may be emitted by the transmitting unit in each case at a predefined wavelength along a predefined direction.

In another advantageous embodiment of the present invention, it is provided that the transmission behavior of the transmit filter element is a function of the transmit filter input direction in such a way that a transmit filter pass range of the transmit filter element changes as a function of the transmit filter input direction. The advantage of this embodiment is that the wavelength of the electromagnetic radiation emitted by the transmitting unit may be tuned.

In one preferred embodiment of the present invention, it is provided that the deflection unit is orientable in such a way that the electromagnetic radiation emitted by the source strikes the transmit filter element along the transmit filter input direction. The filtered electromagnetic radiation is emitted at a transmit wavelength range along a transmit filter output direction into the sensing region. The transmit wavelength range in this case is a function of the transmit filter pass range. The transmit filter output direction may be essentially identical to the perpendicular of the surface of the transmit filter element. The filtered electromagnetic radiation in this case may be emitted along the perpendicular of the surface of the transmit filter element into the sensing region. The transmit filter output direction may also differ from the perpendicular of the surface of the transmit filter element. The filtered electromagnetic radiation in this case may be emitted deflected at an angle to the perpendicular of the surface of the transmit filter element. The advantage of this embodiment is that the electromagnetic radiation may be emitted by the transmitting unit, in each case having a predefined wavelength, along a predefined transmit filter output direction. The tunability may be implemented in a predefined manner, even if the LIDAR sensor includes additional optical elements in the transmitting unit. An additional optical element may, for example, be a beam deflecting element. A beam deflecting element may, for example, be an optical mirror.

In another advantageous embodiment of the present invention, it is provided that the LIDAR sensor further includes at least one receiving unit for receiving electromagnetic radiation backscattered and/or reflected in the sensing region. The receiving unit in this case includes at least one receive filter element for filtering the received electromagnetic radiation. The received electromagnetic radiation strikes the receive filter element along a receive filter input direction. A transmission behavior of the receive filter element is a function of the receive filter input direction. The advantage of this embodiment is that the position and the distance of objects in the surroundings may be determined based on the electromagnetic radiation received along various receive filter input directions. Interfering background radiation may be blocked. The signal-to-noise ratio may be improved.

A receive filter element within the context of the present invention may be understood to be an optical filter.

The receiving unit may have an optical axis. The receive filter input direction may be essentially identical to the perpendicular of the surface of the receive filter element. The electromagnetic radiation in this case may strike the receive filter element along the perpendicular of the surface of the receive filter element. The receive filter input direction may also differ from the perpendicular of the surface of the receive filter element. The electromagnetic radiation in this case may strike the receive filter element deflected at an angle to the perpendicular of the surface of the receive filter element.

The transmission behavior of the receive filter element may be understood within the context of the present invention to mean in which manner the receive filter element is pervious to electromagnetic radiation. A filter element, as previously described, may be specified by various parameters.

In one preferred embodiment of the present invention, it is provided that the transmission behavior of the receive filter element is a function of the receive filter input direction in such a way that a receive filter pass range of the receive filter element changes as a function of the receive filter input direction.

In another preferred embodiment of the present invention, it is provided that at least one transmit filter pass range of the transmit filter element and at least one receive filter pass range of the receive filter element cover a shared wavelength range. The transmit filter element and the receive filter element may have similar or identical parameters. For example, a central wavelength of the transmit filter element and a central wavelength of the receive filter element may be essentially identical. The wavelength range of the transmit filter element and the wavelength range of the receive filter element may overlap. For example, a half-value width of the transmit filter element and a half-value width of the receive filter element may be essentially identical.

An advantage of this embodiment is that the electromagnetic radiation may be emitted having a predefined wavelength along a predefined direction such as, for example, along the transmit filter output direction, in a predefined manner. In a predefined manner may mean that electromagnetic radiation is essentially emitted in one wavelength range and along one direction such as, for example, along the transmit filter output direction, which may also pass the receive filter pass range of the receive filter element after reflection and/or scattering on an object in the sensing region. Electromagnetic radiation, which may be received by the receiving unit, may essentially be emitted in one wavelength range and along one direction. The entire emitted electromagnetic radiation may essentially be used for a measurement.

It is possible that an optical axis of the transmitting unit of the LIDAR sensor is essentially in parallel to an optical axis of the receiving unit. It is possible that the optical axis of the transmitting unit of the LIDAR sensor essentially corresponds to the optical axis of the receiving unit.

Electromagnetic radiation, which is emitted along the optical axis of the transmitting unit into the sensing region, may strike the receive filter element along the optical axis of the receiving unit after reflection and/or scattering on an object. Electromagnetic radiation, which is emitted deflected at an angle from the orientation of the optical axis of the transmitting unit, may, after reflection and/or scattering on an object, strike the receive filter element deflected at an angle from the orientation of the optical axis of the receiving unit. The degrees of these two angles may be essentially identical. This applies, in particular, to objects in the sensing region that are located at a greater distance from the LIDAR sensors.

The LIDAR sensor may be coaxially constructed. For this case, for example, it is possible for a single filter element to assume both the function of the transmit filter element, as well as the function of the receive filter element. This single filter element is pervious to a predefined wavelength range of the electromagnetic radiation emitted by the source. This single filter element filters the electromagnetic radiation backscattered and/or reflected from the sensing region.

In another advantageous embodiment of the present invention, it is provided that the deflection unit is a deflection mirror variably orientable into the sensing region in at least one dimension about the orientation of an optical axis of the transmitting unit. The deflection mirror is preferably designed as a micromirror. A variably orientable deflection mirror may be variably pivotable, for example. It may also be oscillatingly pivotable. Micromirrors are micromechanical mirrors having diameters in the millimeter range. The advantage of this embodiment is that due to the small overall size of the micromirror, the overall size of the LIDAR sensor may also be reduced. Even the lack of macroscopically moved elements may be advantageous.

In another advantageous embodiment of the present invention, it is provided that the wavelength of the electromagnetic radiation emitted by the source is adjustable. The wavelength of the source is tunable. Each transmit filter input direction is assignable one adjustable wavelength of the electromagnetic radiation emitted by the source. The advantage of this embodiment is that the signal-to-noise ratio may be still further improved. The tunable source may be a tunable laser. It may be that the tuning characteristic of the laser is not ideal. If the tuning characteristic exhibits side modes or mode jumps, these may be filtered out with the aid of the transmit filter element. It may also be that the tunable laser is spectrally too wide. Undesirable wavelengths of the electromagnetic radiation may be filtered out with the aid of the transmit filter element.

In one preferred embodiment of the present invention, it is provided that the wavelength of the electromagnetic radiation emitted by the source is adjustable as a function of the existing deflection direction. The advantage of this embodiment is that essentially electromagnetic radiation may be emitted by the transmitting unit which may be received by the receiving unit.

In another advantageous embodiment of the present invention, it is provided that the transmit filter element and/or the receive filter element is/are formed from multiple layers. One of the multiple layers in this case includes a transparent electrode for thermal stabilization of the transmission behavior of the transmit filter element and/or of the receive filter element. The advantage of this embodiment is that the half-value width of the transmit filter element and/or of the receive filter element may be still further reduced. To compensate for a shifting of the central wavelength to longer wavelengths with rising temperature, the half-value width of a filter element is usually selected to be somewhat wider. The thermal operating range is reduced as a result of the thermal stabilization of the transmit filter element and/or of the receive filter element. As a result, it may be possible that the transmit filter element and/or the receive filter element no longer experiences/experience a temperature difference of, for example, 125 K (for example, from −40° C. to +85° C.). Instead, it is possible that the transmit filter element and/or the receive filter element experiences/experience a temperature fluctuation of, for example, only 55 K. The transmit filter element and/or the receive filter element may be tempered in such a way that their temperature never falls below 30° C., for example. The transmit filter element and/or the receive filter element may be tempered by applying a current to the transparent electrode. The transparent electrode may include indium tin oxide (ITO), for example.

In one method according to the present invention for activating a LIDAR sensor for detecting an object within a sensing region, the LIDAR sensor includes at least one transmitting unit. The method includes a step of emitting electromagnetic radiation with the aid of a source. The method also includes a step of deflecting the electromagnetic radiation emitted by the source with the aid of a deflection unit along a deflection direction. The method further includes a step of filtering the electromagnetic radiation deflected by the deflection unit with the aid of a transmit filter element, which the electromagnetic radiation strikes along a transmit filter input direction. In this case, a transmission behavior of the transmit filter element is a function of the transmit filter input direction. The method also includes a step of emitting the filtered electromagnetic radiation along a transmit filter output direction into the sensing region.

In one advantageous embodiment of the method, it is provided that the transmission behavior of the transmit filter element is a function of the transmit filter input direction in such a way that a transmit filter pass range of the transmit filter element changes as a function of the transmit filter input direction. It is further provided that the deflection unit is oriented in such a way that the electromagnetic radiation emitted by the source along the transmit filter input direction strikes the transmit filter element. The filtered electromagnetic radiation is emitted at a transmit wavelength range along a transmit filter output direction into the sensing region. The transmit wavelength range is a function of the transmit filter pass range.

In another advantageous embodiment of the present invention, it is provided that the wavelength of the electromagnetic radiation emitted by the source is adjusted as a function of the present deflection direction.

In another advantageous embodiment of the present invention, it is provided that the transmit filter element and/or an optionally additionally present receive filter element is/are formed of multiple layers. One of the multiple layers includes a transparent electrode. The transparent electrode is tempered in such a way that the transmission behavior of the transmit filter element and/or of the receive filter element remains stable.

In sum, the LIDAR sensor according to the present invention yields advantages as compared to previous systems. Electromagnetic radiation may essentially be emitted in one wavelength range and along one direction which, after reflection and/or scattering on an object in the sensing region, may also pass the receive filter pass range of the receive filter element. As a result, it is possible that not the envelope of all of the transmission characteristics of the receive filter element, which arise as a result of the different angles of incidence, need be selected as a half-value width of a bandpass filter. The half-value width of the receive filter element may be significantly reduced. It may, for example, be significantly below 30-40 nm. The receive filter pass range of the receive filter element may be narrowband compared to previous systems. It is possible to block interfering background noise even better. At a constant output of electromagnetic radiation emitted by the transmitting unit, it is possible as a result to improve the signal-to-noise ratio of the LIDAR sensor. The dynamic range of the detector may be improved. Power losses and thermal developments may be avoided. The signal quality may be improved with maintained eye safety. In addition, electromagnetic radiation may be emitted by the transmitting unit with a power, which may be essentially fully received by the receiving unit. This power may be adapted in such a way that a mandatory eye safety based on statutory regulations may be ensured.

### BRIEF DESCRIPTION OF THE DRAWINGS

One exemplary embodiment of the present invention is explained in greater detail below with reference to the figures.

FIG. 1 shows the structure and beam path of the transmitting unit of a LIDAR sensor according to one embodiment variant of the present invention.

FIG. 2 shows the filter characteristic of a transmit filter element and/or of a receive filter element in a LIDAR sensor.

FIG. 3 shows the structure and beam path of the receiving unit of a LIDAR sensor according to one embodiment variant of the present invention.

FIG. 4A shows the wavelength distributions of the electromagnetic radiation emitted by a source before filtering with the aid of a transmit filter element.

FIG. 4B shows the wavelength distributions of the electromagnetic radiation after filtering with the aid of a transmit filter element.

FIG. 5 shows the wavelength distribution of the electromagnetic radiation striking the receive filter element.

FIG. 6 shows a method for activating a LIDAR sensor.

### DETAILED DESCRIPTION OF EXAMPLE EMBODIMENTS

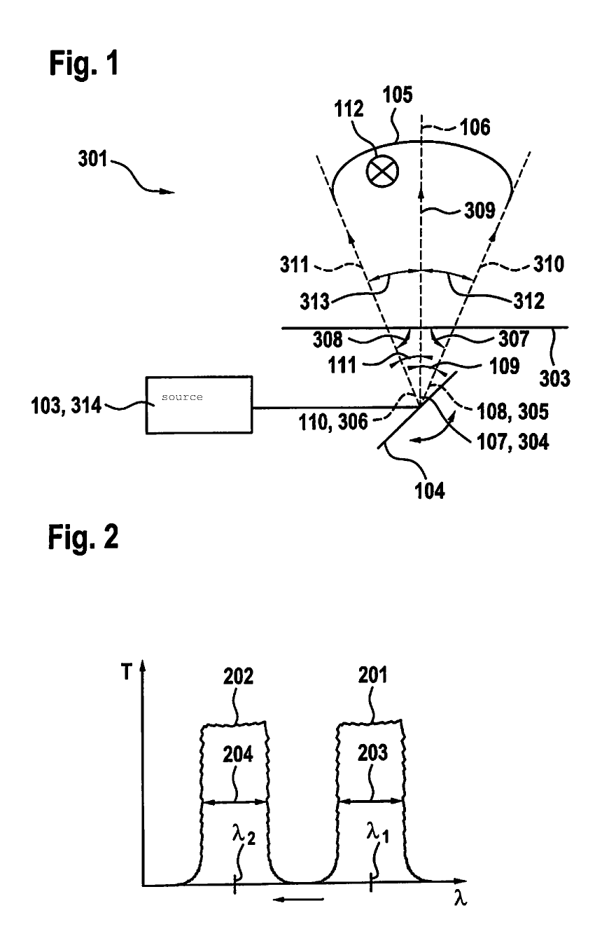

FIG. 1 shows the structure and beam path of a transmitting unit 301 of a LIDAR sensor according to one embodiment variant of the present invention. Transmitting unit 301 includes a source 103 or 314, a deflection unit 104 and a transmit filter element 303. Line 106 marks the orientation of the optical axis of transmitting unit 301 into the sensing region. The sensing region is depicted two-dimensionally in the example. It spans an angular range 105. The sensing region may also be three-dimensional and be spanned by a solid angle.

Electromagnetic radiation may be emitted by source 103 or 314. The source may be designed as a laser 103 or 314. The emitted electromagnetic radiation strikes a deflection unit 104 and is deflected by the deflection unit along various directions into the sensing region. The electromagnetic radiation is deflected at various angles into the sensing region. The deflection may take place, for example, along deflection directions 107, 108 and 110. The electromagnetic radiation may be deflected along deflection direction 107, along the perpendicular of the surface of transmit filter element 303. The electromagnetic radiation may be deflected along deflection direction 108, which differs from the perpendicular of the surface of the transmit filter element. In this case, the electromagnetic radiation may be deflected at an angle 109 from the perpendicular of the surface of transmit filter element 303. The electromagnetic radiation may be deflected along deflection direction 110, which differs from the perpendicular of the surface of the transmit filter element. The electromagnetic radiation in this case may be deflected at an angle 111 from the perpendicular of the surface of transmit filter element 303. Angles 109 and 111 may be essentially identical in terms of their degree.

The electromagnetic radiation deflected by deflection unit 104 may strike transmit filter element 303 in a transmit filter input direction 304, which is essentially identical to the perpendicular of the surface of transmit filter element 303. Transmit filter input direction 304 may correspond to deflection direction 107. If transmit filter element 303 is pervious to this electromagnetic radiation (see in this regard the description for FIG. 2), then the electromagnetic radiation is emitted into the sensing region along a transmit filter output direction 309, which is essentially identical to the perpendicular of the surface of transmit filter element 303

The electromagnetic radiation deflected by deflection unit 104 may strike transmit filter element 303 along a transmit filter input direction 305, which differs from the perpendicular of the surface of transmit filter element 303. Transmit filter input direction 305 may correspond to deflection direction 108. The electromagnetic radiation in this case strikes transmit filter element 303 at an angle 307 deflected from the perpendicular of the surface of transmit filter element 303. If transmit filter element 303 is pervious to this electromagnetic radiation (see in this regard the description for FIG. 2), then the filtered electromagnetic radiation is emitted along a transmit filter output direction 310, which differs from the perpendicular of the surface of transmit filter element 303. The filtered electromagnetic radiation is emitted into the sensing region deflected at angle 312 from the perpendicular of the surface of transmit filter element 303.

The electromagnetic radiation deflected by deflection unit 104 may strike transmit filter element 303 along a transmit filter input direction 306, which differs from the perpendicular of the surface of transmit filter element 303. Transmit filter input direction 306 may correspond to deflection direction 110. The electromagnetic radiation in this case strikes transmit filter element 303 deflected at an angle 308 from the perpendicular of the surface of transmit filter element 303. If transmit filter element 303 is pervious to this electromagnetic radiation (see in this regard the description for FIG. 2), then the filtered electromagnetic radiation is emitted along a transmit filter output direction 311, which differs from the perpendicular of the surface of transmit filter element 303. The filtered electromagnetic radiation is emitted into the sensing region deflected at angle 313 from the perpendicular of the surface of transmit filter element 303.

In one specific embodiment, the source may be designed as a continuous wave laser 103. In another specific embodiment, the source may be designed as a pulsed laser. In one alternative specific embodiment, the source may be designed as a tunable laser 314.

In one specific embodiment, transmit filter element 303 may be constructed of layers. One of the layers may include a transparent electrode.

FIG. 2 shows by way of example a transmission behavior of a filter element. In this case, FIG. 2 may show both the transmission behavior of a transmit filter element 303, as well as the transmission behavior of a receive filter element 113 in a LIDAR sensor. Transmit filter element 303 and/or receive filter element 113 may be designed as a bandpass filter. In the diagram shown, transmission degree T of a transmit filter element 303 and/or of a receive filter element 113 is plotted over the wavelength A of the emitted or backscattered and/or reflected electronic radiation. Transmission degree T indicates the ratio of the radiation intensity admitted by transmit filter element 303 and/or receive filter element 113 to the striking radiation intensity.

Curve 201 shows, for example, the transmission behavior of transmit filter element 303 for electromagnetic radiation, which strikes transmit filter element 303 along transmit filter input direction 304, along the perpendicular of the surface of transmit filter element 303. Transmit filter element 303 in this case has central wavelength λ₁ and spectral width 203. Essentially only electromagnetic radiation in wavelength range 203 may pass transmit filter element 303. The filtered electromagnetic radiation may be emitted into the sensing region along transmit filter output direction 309.

With the aid of deflection unit 104, it is possible to predefine a direction, as here, for example, transmit filter input direction 304 or transmit filter output direction 309. This direction may be assigned a wavelength of the electromagnetic radiation as here, for example, in wavelength range 203.

Curve 202 shows the transmission behavior of transmit filter element 303 for electromagnetic radiation, which strikes transmit filter element 303, for example, along transmit filter input direction 305 deflected at angle 307 to the perpendicular of the surface of transmit filter element 303, or along transmit filter input direction 306, deflected at angle 308 to the perpendicular of the surface of transmit filter element 303. The degrees of angles 307 and 308 are essentially identical in the example. Transmit filter element 303 for this case has central wavelength λ₂ and spectral width 204. The greater the degrees of angles 307 and 308 are, the more the transmission behavior of transmit filter element 303 may shift toward shorter wavelengths. The greater the degrees of angles 307 and 308 are, the more the central wavelength of transmit filter element 303, for example, may shift toward shorter wavelengths. Essentially only electromagnetic radiation in wavelength range 204 is able to pass transmit filter element 303. The filtered electromagnetic radiation may be emitted into the sensing region along transmit filter output direction 310 or along transmit filter output direction 311.

With the aid of deflection unit 104, it is possible to predefine a direction, such as here, for example, transmit filter input direction 305 or transmit filter output direction 310 or transmit filter input direction 306 or transmit filter output direction 311. These directions may each be assigned a wavelength of electromagnetic radiation, such as here, for example, in wavelength range 204.

The electromagnetic radiation filtered by transmit filter element 303 is emitted into the sensing region. An object 112, for example, as shown in FIG. 1, may be located in the sensing region. The emitted electromagnetic radiation may be scattered and/or reflected on this object. The scattered and/or reflected electromagnetic radiation may then strike receiving unit 302 of the LIDAR sensor.

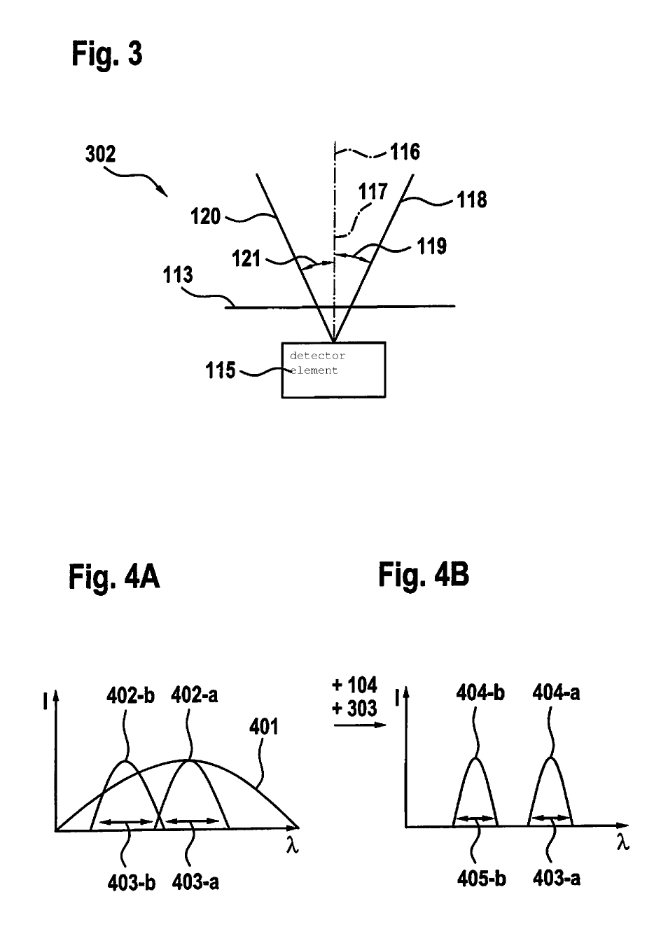

FIG. 3 shows the example of a receiving unit 302 of a LIDAR sensor. This receiving unit may include a receive filter element 113 and a detector element 115. Line 116 marks the optical axis of receiving unit 302.

Electromagnetic radiation may strike receive filter element 113, for example in receive filter input direction 117, along the perpendicular of the surface of receive filter element 113. Line 118 marks a second receive filter input direction. Electromagnetic radiation from receive filter input direction 118, deflected at angle 119 to the perpendicular of the surface of receive filter element 113, strikes receive filter element 113. Line 120 marks a third receive filter input direction. Electromagnetic radiation from receive filter input direction 120, deflected at angle 121 to the perpendicular of the surface of receive filter element 113, strikes receive filter element 113. Angles 119 and 121 may be identical in terms of their degree. If receive filter element 113 is pervious to the striking electromagnetic radiation, then the correspondingly filtered electromagnetic radiation may strike detector 115.

In one specific embodiment, receive filter element 113 may be constructed of layers. One of these layers may include a transparent electrode.

As mentioned, FIG. 2 also shows, for example, the transmission behavior of receive filter element 113. Curve 201, for example, shows the transmission behavior of receive filter element 113 for electromagnetic radiation, which strikes receive filter element 113 along receive filter input direction 117, along the perpendicular of the surface of receive filter element 113. Receive filter element 113 in this case has central wavelength λ₁ and spectral width 203. Essentially, only electromagnetic radiation in wavelength range 203 may pass receive filter element 113. The filtered electromagnetic radiation may strike detector 115.

Curve 202 shows the transmission behavior of receive filter element 113 for electromagnetic radiation, which strikes receive filter element 113, for example, along receive filter input direction 118, deflected at angle 119 to the perpendicular of the surface of receive filter element 113, or along receive filter input direction 120, deflected at angle 121 to the perpendicular of the surface of receive filter element 113. The degrees of angles 119 and 121 in the example, are essentially identical. Receive filter element 113 in this case has central wavelength λ₂ and spectral width 204. The greater the degrees of angles 119 and 121 are, the more the transmission behavior of receive filter element 113 may shift toward shorter wavelengths.

The greater the degrees of angles 119 and 121 are, the more the central wavelength of receive filter element 113, for example, may shift toward shorter wavelengths. Essentially, only electromagnetic radiation in wavelength range 204 may pass transmit filter element 303. The filtered electromagnetic radiation may strike detector 115.

The transmission behavior of transmit filter element 303 and the transmission behavior of receive filter element 113 may be essentially identical. Thus, for example, at least one transmit filter pass range of transmit filter element 303 and at least one receive filter pass range of receive filter element 113 may cover a shared wavelength range. Electromagnetic radiation at a wavelength λ₂, for example, is emitted by transmitting unit 301 into the sensing region along transmit filter output direction 310 or 311. After reflection and/or scattering on an object 112 in the sensing region, the electromagnetic radiation strikes the receive filter element in a receive filter input direction 118 or 120. The electromagnetic radiation may also have a wavelength λ₂ and thus pass the receive filter pass range of receive filter element 113 essentially without signal losses. The same applies to electromagnetic radiation having a wavelength λ₁, which is emitted into the sensing region along transmit filter output direction 309.

FIG. 4A shows by way of example the wavelength distribution of the electromagnetic radiation emitted directly from a source 103 or 314. Here, the electromagnetic radiation has not yet been filtered by any transmit filter element 303. In the diagram, the intensity I is plotted over wavelength λ. Curve 401 shows, for example, the wavelength distribution of the emitted electromagnetic radiation of a transmitting unit 301 having a broadband laser as a source 103.

If a transmitting unit 301 of a LIDAR sensor includes a tunable laser 314, then different wavelengths of electromagnetic radiation may be emitted from this laser. Curve 402-a shows, for example, a wavelength distribution of the emitted electromagnetic radiation of a first wavelength. The electromagnetic radiation in this case has spectral width 403-a. Curve 402-b shows, for example, a wavelength distribution of the emitted electromagnetic radiation of a second wavelength. The electromagnetic radiation in this case has spectral width 403-b.

FIG. 4B shows by way of example the wavelength distribution of the electromagnetic radiation emitted by a transmitting unit 301 according to the present invention. As described in FIG. 2, it is possible with the aid of deflection unit 104 and transmit filter element 303 to predefine a direction in which the electromagnetic radiation is emitted and this direction is assigned a wavelength of the electromagnetic radiation.

The electromagnetic radiation emitted by source 103 or 314 along transmit filter input direction 304 may, for example, strike transmit filter element 303. As a result of the transmission behavior of transmit filter element 303, electromagnetic radiation of wavelength distribution 404-a may in this case essentially be filtered out of the electromagnetic radiation having wavelength distribution 401 and emitted into the sensing region.

For example, the electromagnetic radiation emitted by source 103 or 314 may strike transmit filter element 303 also along transmit filter input direction 305 or along transmit filter input direction 306. As a result of the transmission behavior of transmit filter element 303, electromagnetic radiation of wavelength distribution 404-b may in this case essentially be filtered out of the electromagnetic radiation having wavelength distribution 401 from the two transmit filter input directions 305 and 306, and emitted into the sensing region.

If the LIDAR sensor has a tunable laser 314 as a source, then spectral widths 403-a and 403-b of the electromagnetic radiation may be reduced to spectral widths 405-a and 405-b. The power elements lying outside the angle-dependent transmission behavior are filtered out. In the case of a tunable laser 314, a smaller portion of the laser power emitted by source 314 is filtered out as compared to a broadband laser. The system efficiency in this case may be better.

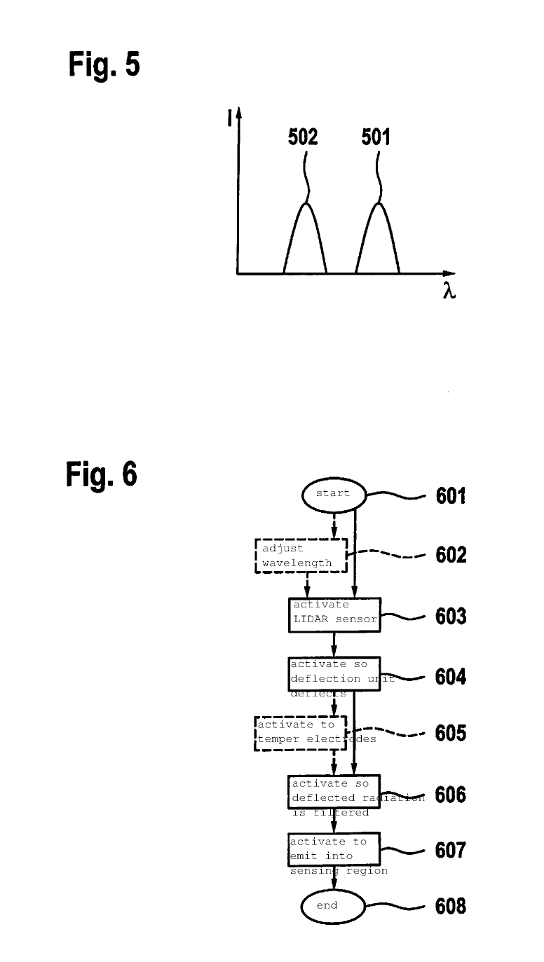

FIG. 5 shows the wavelength distribution of electromagnetic radiation striking receive filter element 113 of receiving unit 302. Curve 501 shows by way of example the wavelength distribution of the electromagnetic radiation arriving along receive filter input direction 117. Curve 502 shows the wavelength distribution of electromagnetic radiation, which strikes receive filter element 113 along a receive filter input direction 118 and 120. In the example, the degrees of angle 119 and of angle 121, at which the striking electromagnetic radiation in each case is deflected away from the perpendicular of the surface of the receive filter element, are essentially identical.

Wavelength distribution 404-a or 404-b shown in FIG. 4B may be essentially retained after reflection and/or scattering on an object 112 in the sensing region. Wavelength distribution 404-a of the emitted electromagnetic radiation then corresponds essentially to wavelength distribution 501 of the electromagnetic radiation striking receive filter element 113. Wavelength distribution 404-b of the emitted electromagnetic radiation then corresponds essentially to wavelength distribution 502 of the electromagnetic radiation striking receive filter element 113. As previously mentioned, at least one transmit filter pass range of transmit filter element 303 and at least one receive filter pass range of receive filter element 113, for example, may cover a shared wavelength range. The electromagnetic radiation emitted by transmitting unit 301 at a predefined wavelength and along a predefined direction may pass the receive filter pass range of receive filter element 113 essentially without signal losses. Receive filter element 113 may be narrow-band. Noise from the background radiation may be essentially filtered out. The signal-to-noise ratio may be improved.

FIG. 6 shows by way of example a method for activating a LIDAR sensor for detecting an object 112 within a sensing region 105. The method starts with step 601. In step 603, the LIDAR sensor may be activated in such a way that a source 103 or 314 emits electromagnetic radiation. In step 604, the LIDAR sensor may be activated in such a way that a deflection unit 104 deflects the electromagnetic radiation emitted by source 103 or 314 along a deflection direction (for example, 107, 108 or 110). In step 606, the LIDAR sensor may be activated in such a way that the electromagnetic radiation deflected by deflection unit 104 may be filtered with the aid of a transmit filter element 303. In step 607, the LIDAR sensor may be activated in such a way that the filtered electromagnetic radiation is emitted into the sensing region 105 along a transmit filter output direction (for example, 309, 310 or 311). The method ends in step 608.

Step 602 may optionally be carried out between start 601 and step 603. In step 602, the wavelength of the electromagnetic radiation emitted by a tunable source 314 may be adjusted as a function of the present deflection direction.

A step 605 may optionally be carried out between steps 604 and 606. In step 605, the LIDAR sensor may be activated in such a way that electrodes of transmit filter element 303 constructed of layers and/or electrodes of receive filter element 113 constructed of layers may be tempered to a predefined temperature.

What is claimed is:

1. A LIDAR sensor for detecting an object within a sensing region, comprising:
at least one transmitting unit including at least one source for emitting electromagnetic radiation, and at least one deflection unit for deflecting electromagnetic radiation emitted by the source into the sensing region along a deflection direction, the transmitting unit further including at least one transmit filter element for filtering the electromagnetic radiation deflected by the deflection unit, which the electromagnetic radiation strikes along a transmit filter input direction;
wherein a transmission behavior of the transmit filter element is a function of the transmit filter input direction.

2. The LIDAR sensor as recited in claim 1, wherein the deflection direction corresponds to the transmit filter input direction.

3. The LIDAR sensor as recited in claim 1, wherein the transmission behavior of the transmit filter element is a function of the transmit filter input direction in such a way that a transmit filter pass range of the transmit filter element changes as a function of the transmit filter input direction.

4. The LIDAR sensor as recited in claim 3, wherein the deflection unit is orientable in such a way that the electromagnetic radiation emitted by the source along the transmit filter input direction (304, 305, 306) strikes the transmit filter element, and the filtered electromagnetic radiation is emitted into the sensing region in a transmit wavelength range along a transmit filter output direction, the transmit wavelength range being a function of the transmit filter pass range.

5. The LIDAR sensor as recited in claim 1, further comprising:
at least one receiving unit for receiving electromagnetic radiation at least one of backscattered and reflected in the sensing region, the receiving unit including at least one receive filter element for filtering the received electromagnetic radiation, and the received electromagnetic radiation striking the receive filter element along a receive filter input direction;
wherein a transmission behavior of the receive filter element is a function of the receive filter input direction.

6. The LIDAR sensor as recited in claim 5, wherein the transmission behavior of the receive filter element is a function of the receive filter input direction in such a way that a receive filter pass range of the receive filter element changes as a function of the receive filter input direction.

7. The LIDAR sensor as recited in claim 6, wherein at least one transmit filter pass range of the transmit filter element and at least one receive filter pass range of the receive filter element cover a shared wavelength range.

8. The LIDAR sensor as recited in claim 7, wherein the deflection unit is a deflection mirror variably orientable into the sensing region in at least one dimension about the orientation of an optical axis of the transmitting unit.

9. The LIDAR sensor as recited in claim 8, wherein the deflection mirror is a micromirror.

10. The LIDAR sensor as recited in claim 1, wherein the wavelength of the electromagnetic radiation emitted by the source is adjustable and each transmit filter input direction is assignable an adjustable wavelength of the electromagnetic radiation emitted by the source.

11. The LIDAR sensor as recited in claim 9, wherein the wavelength of the electromagnetic radiation emitted by the source is adjustable as a function of a present deflection direction.

12. The LIDAR sensor as recited in claim 5, wherein at least one of the transmit filter element and the receive filter element is formed of multiple layers, one of the multiple layers including a transparent electrode for thermal stabilization of the transmission behavior of the at least one of the transmit filter element and the receive filter element.

13. A method for activating a LIDAR sensor for detecting an object within a sensing region, the LIDAR sensor including at least one transmitting unit, the method comprising:
emitting electromagnetic radiation with the aid of a source;
deflecting the electromagnetic radiation emitted by the source with the aid of a deflection unit along a deflection direction;
filtering the electromagnetic radiation deflected by the deflection unit with the aid of a transmit filter element, which the electromagnetic radiation strikes along a transmit filter input direction, and a transmission behavior of the transmit filter element being a function of the transmit filter input direction; and
emitting the filtered electromagnetic radiation along a transmit filter output direction into the sensing region.

14. The method as recited in claim 13, wherein:
the transmission behavior of the transmit filter element is a function of the transmit filter input direction in such a way that a transmit filter pass range of the transmit filter element changes as a function of the transmit filter input direction; and
the deflection unit is oriented in such a way that the electromagnetic radiation emitted by the source along the transmit filter input direction strikes the transmit filter element, the filtered electromagnetic radiation being emitted in a transmit wavelength range along a transmit filter output direction into the sensing region, the transmit wavelength range being a function of the transmit filter pass range.

15. The method as recited in claim 14, wherein the wavelength of the electromagnetic radiation emitted by the source is adjusted as a function of a present deflection direction.

16. The method as recited in claim 13, wherein at least one of the transmit filter element and a receive filter element is formed of multiple layers, one of the multiple layers including a transparent electrode, and the transparent electrode being tempered in such a way that the transmission behavior of the at least one of the transmit filter element and the receive filter element remains stable.
